(19) United States
(12) Patent Application Publication
(10) Pub. No.: US 2004/0006743 A1
(43) Pub. Date: Jan. 8, 2004

(54) Method and apparatus for re-editing and redistributing web documents

(76) Inventors: Kazushige Oikawa, San Jose, CA (US); Daisuke Kurosaki, Chiba-ken (JP); Yuzuru Tanaka, Hokkaido (JP)

Correspondence Address: BIRCH STEWART KOLASCH & BIRCH, PO BOX 747, FALLS CHURCH, VA, 22040-0747, US

(21) Appl. No.: 10/443,863

(22) Filed: May 23, 2003

(30) Foreign Application Priority Data
May 24, 2002 (JP) 151190/2002

(51) Int. Cl. G06F 15/16

(52) U.S. Cl. 715/513; 709/219

(57) ABSTRACT

An object of the present invention is to re-edit and redistribute a WWW document with services embedded therein according to a user's will. Portions of Web pages are extracted and combined together to compose a new document. If a portion to be extracted contains a dynamic content, its copy is kept alive, that is, the content of the copy is periodically updated.

Object-oriented IntelligentPad technology is used to extract portions of Web documents and wrap them with a pad wrapper. The function of periodically accessing a server is included in the wrap of a dynamic Web document portion to compose an object called a view pad having an automatic, periodic refresh function.

### BACKGROUND OF THE INVENTION

The present invention relates to a WWW (World Wide Web) technology and in particular to a technology for re-editing WWW contents open to the public and redistributing the re-edited contents.

Present-day WWW technologies provide repositories for publishing multimedia documents in HTML worldwide, navigating through the multimedia documents, and browsing any of them.

Any services can be embedded in an HTML document to be published. A server, such as a database server, a file server, and an application server for example, can be provided for defining these services. A portion of the HTML document can be defined so as to display its corresponding current value outputted from the server when it is accessed. Whenever the HTML document is refreshed or re-accessed, the content of a specified portion can be modified. Example of this type of dynamic content includes stock prices on a stock market information page and the current location of the Space Station disclosed on the Space Station homepage.

A number of technologies are available that enable a user to modify documents published on the WWW.

For example, a user-customizable portal site such as MyYahoo® (http://my.yahoo.co.jp/) provides a method for personalizing a Web page. When a user registers his or her interests on that site, the system customizes the Web page so that it displays only the information concerning those interests. This type of system can customize only a limited portion of a Web document in a restricted manner. Moreover, this type of Web service only allows the documents to be accessed that are managed by it.

According to HTML specification 4.01 (http://www.w3.org/TR/html4/), HTML 4.01 provides the special HTML tag <iframe>, namely an inline frame, for embedding a given Web document in a target Web page. However, this technology does not allow the user to directly specify a portion of a Web document to be extracted or a location in a target document in which an extracted document is to be inserted. Accordingly, for such a purpose, the user must edit HTML definitions themselves or per se.

A technology called programming-by-demonstration for supporting the function of re-editing Web documents is employed in Turquoise [R. C. Miller, B. A. Myers, Creating Dynamic World Wide Web Pages By Demonstration. Carnegie Mellon University School of Computer Science Tech. Report, CMU-CS-97-131, 1997.] and Internet Scrapbook [A. Sugiura, Y. Koseki, Internet Scrapbook: Automating Web Browsing Tasks by Demonstration. Proc. of the ACM Symposium on User Interface Software and Technology (UIST), pp.0-18, 1998.]. This technology allows the user to simulate on screen a method for modifying the layout of a Web page to program it in order to define a customized Web page. Whenever the Web page is accessed to refresh, the same programmed editing rule can be used. Although the technology allows the layout to be modified, it allows any components to be neither extracted nor functionally connected together.

Transpublishing [T. H. Nelson, transpublishing for Today's web: Our Overall Design and Why it is Simple. http://www.sfc.keio.ac.jp/ted/TPUB/Tqdesign99.html, 1999.] allows a Web document to be embedded in a Web page. This proposes the function of managing licenses such as the copyrights of documents quoted and an accounting function for the documents. However, document embedding by this technology requires special HTML tags.

Examples of tools for extracting a document component from a Web document include W4F [A. Sahuguet, F. Azavant, Building Intelligent Web Applications Using Lightweight wrappers. Data and knowledge Engineering, 36 (3), pp.283-316, 2001. and A. Sahuguet, F. Azavant, Wysiwyg Web Wrapper Factory (W4F). http://db.cis.upenn.edu/DL/www8.pdf, 1999.] and DEByE [B. A. Ribeiro-Neto, A.H.F. Laender, A.S. Da Silva. Extracting Semistructured Data Through Examples. Proc. of the 8th ACM int'l Conf. On Information and knowledge Management (CIKM '99), pp.91-101, 1999.]. W4F provides a GUI support tool for defining extraction. However, it requires the user to write some script programs and therefore requires the knowledge of programming for linking information. DEByE provides a more powerful GUI support tool. However, it outputs an extracted document component in XML format and therefore, the knowledge of XML is required to reuse it.

Present-day WWW technologies including those described above cannot allow a document having embedded services to be re-edited or redistributed without restraint.

They allow a user to select an optional portion of text in a Web page through a mouse operation to copy and paste it in a local document in MS-Worde format. However, given portions of a Web page can be neither extracted without restraint nor combined together to construct a new document. Especially when a portion to be extracted includes a dynamic content, it is desirable that its copy be alive, that is, the content be updated on a regular basis.

Therefore an object of the present invention is to provide the functions of:

(1) extracting easily any portion of a Web document along with its style,

(2) keeping a dynamic content alive after it is re-edited,

(3) combining extracted portions of a Web document with each other to thereby easily re-edit the document along with Web services embedded in it in order to define both of a new layout and a new functional configuration, and

(4) redistributing easily the re-edited document on the Internet.

### SUMMARY OF THE INVENTION

In order to achieve the object, the present invention proposes a system using Visual Object, which is an objectoriented technology that provides the following functions:

(1) The function of wrapping a given object with a standard visual wrapper in order to define a media object having a two- or three-dimensional representation on a display screen. The object to be wrapped may be a multimedia document, an application program, or any combination of them.

(2) The function of re-editing the media object defined by the above function (1). A given component media object can be directly combined with another component or a composite media object to create a composite media object and the linkage between them can be defined on the display screen through a mouse operation. In addition, any component media object can be extracted from the composite media object.

(3) The function of redistributing the media object defined by the function (1). The media object is a permanent object that can be sent and received over the Internet to be reused.

In particular, the present invention uses IntelligentPad as the visual object for implementing the system having these functions. IntelligentPad is a two-dimensional media object system. Media objects of the system are called pads.

At implementation level, the objects of the present invention can therefore be translated as follows:

(1) To provide the function of extracting given portions of a Web document and wrapping it with a pad wrapper.

(2) To provide the function of incorporating a periodical server access function into the wrap of a dynamic Web document portion. A document of this type having the automatic, periodical refresh function is called a live document.

If these objects are achieved, IntelligentPad can provide through its intrinsic functions, which will be described later, solutions to both of the problems of easily re-editing a Web service in conjunction with the linkage between the functions and easily redistributing the re-edited document on the Internet.

### BRIEF DESCRIPTION OF THE DRAWINGS

FIG. 1 is a schematic diagram of internal configuration of a view pad according to the present invention;

FIG. 2 shows an HTML document and its DOM tree and a path expression;

FIG. 3 shows the DOM tree and path expression of a virtual node;

FIG. 4 shows operations of edit operators on a DOM tree;

FIG. 5 shows an INSERT type by the INSERT operator;

FIG. 6 shows an operation for selecting a portion to edit on an HTML document;

FIG. 7 shows a live extraction of an element with a mouse drag operation;

FIG. 8 shows a direct operation for removing an element from a view;

FIG. 9 shows a direct operation for inserting a view into another view;

FIG. 10 shows mapping of a text character string node for defining a slot;

FIG. 11 shows mapping of a table node for defining a slot;

FIG. 12 shows mapping of an anchor element for defining three slots;

FIG. 13 shows mapping of a form element for defining three slots;

FIG. 14 shows plotting of the orbit of the NASA Space Station and the orbit of the Yohkoh satellite;

FIG. 15 shows real-time drawing of a stock price chart through the use of a live copy;

FIG. 16 shows a real-time drawing of a stock price chart through the use of a live copy of a table element; and

FIG. 17 shows creation of a map tool through the use of a map service and its control panels.

### DETAILED DESCRIPTION OF THE INVENTION

In order to provide a background knowledge concerning the present invention, Media Object [Y. Tanaka. Meme media and a world-wide meme pool. In Proc. ACM Multimedia 96, pp.175-186, 1996. and Y. Tanaka. Memes: New Knowledge Media for Intellectual resources. Modern Simulation and Training, 1, pp.22-25, 2000.] and IntelligentPad will be briefly described.

Architectures called “meme media” and “meme market” have been studied and developed since 1987. In 1989 and 1995, two- and three-dimensional meme media architectures, respectively, were developed, which are “IntelligentPad” [Y. Tanaka, and T. Imataki. IntelligentPad: A Hypermedia System allowing Functional Composition of Active Media Objects through Direct Manipulations. In Proc. of IFIP '89, pp.541-546, 1989. and Y. Tanaka, A. Nagasaki, M. Akaishi, and T. Noguchi. Synthetic media architecture for an object-oriented open platform. In Personal Computers and Intelligent Systems, Information Processing 92, Vol. III, North Holland, pp.104-110, 1992. and Y. Tanaka. From augmentation media to meme media: IntelligentPad and the world-wide repository of pads. In Information Modelling and Knowledge Bases, VI (ed. H. Kangassalo et al.), IOS Press, pp.91-107, 1995.] and “IntelligentBox” [Y. Okada and Y. Tanaka. IntelligentBox: A constructive visual software development system for interactive 3D graphic applications. Proc. of the Computer Animation 1995 Conference, pp.114-125, 1995.]. Besides their applications and improvements, their pools and market architectures have been developed.

“IntelligentPad” displays each component as a pad (an image of a sheet of paper on a screen). A pad can be pasted onto another pad to define a physical inclusion relation between them and a linkage between their functions. For example, when a pad P2 is pasted onto another pad P1, the pad P2 becomes a child of the pad P1 and, at the same time, P1 becomes the parent of P2. One pad cannot have more than one parent pad. In order to define various types of multimedia documents and application tools, a plurality of pads can be pasted on one pad. The composite pad can be decomposed and re-edited at any time unless set otherwise.

In other words, IntelligentPad is visual-programmable, object-oriented infrastructure software that allows objects to be associated with each other. Components called “pads” with functions are combined, decomposed, and, reused to develop a piece of software and also provide an operating environment for the developed pads. A “pad” is a kind of object. It consists of a model part having a structure called a “slot” for retaining a state of the pad, a view part, which exchanges messages with the model part and defines the display format of the pad, and a controller part, which accepts a user operation and defines a reaction of the pad. It behaves as the basic unit in which its own data and method are encapsulated. A pad can exchange data and messages with another pad through the use of the slot as a common interface. As described above, pads can be pasted onto and pasted out from each other to visually combine and decompose in a GUI environment. Details of IntelligentPad are disclosed in publications and the IntelligentPad Consortium (IPC: http://www.pads.or.jp/).

All types of knowledge fragments in object-oriented component architectures are defined as objects.

IntelligentPad uses an object-oriented component architecture and a wrapper architecture. Instead of directly dealing with component objects, IntelligentPad wraps each object with a standard pad wrapper and treats it as a pad. Each pad has a standard user interface and a standard connection interface. The user interface of a pad has a card-like view on the screen and includes a set of standard operations such as “move”, “resize”, “copy”, “paste”, and “paste out” of a pad from a composite pad.

A user can readily replicate any pad, paste a pad onto another, and paste out a pad from a composite pad. Pads are decomposable permanent objects. Any composite pad can readily be decomposed simply by pasting out a primitive pad or composite pad from a parent pad.

Each pad provides a list of slots that function as connecting jacks of an AV (Audio Visual) system component as its connection interface and a single connection to a slot of its parent pad. Each pad uses a standard set of messages, “set” and “get” for accessing the single slot of the parent pad and another message “update” for propagating a change of its state to its child pad(s). In their default definitions, a “set” message sends its parameter value to its recipient slot whereas a “get” message requests a value from its recipient slot.

Embodiments

An object-oriented method and apparatus according to the present invention that provide a live document for re-editing and redistributing WWW contents are implemented by IntelligentPad called a view pad having a structure described below.

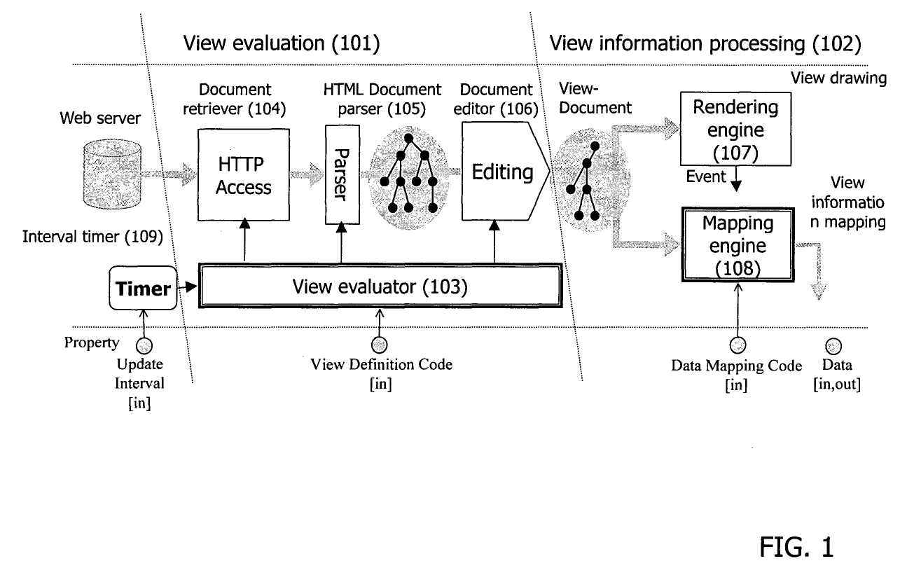

FIG. 1 is a schematic diagram showing an internal configuration of a view pad according to the present invention.

A view pad broadly consists of two parts. Reference numeral 101 indicates a part for evaluating views and reference numeral 102 indicates a part for processing view information. Part 101 consists of a view evaluator 103 for processing view definitions (described later) and controlling a view evaluation process, a document retriever 104, an HTML document parser 105, and a document editor 106. Part 102 consists of a rendering engine 107 for view documents and a mapping engine 108 for mapping view information.

In a view evaluation process, an HTML view is evaluated according to a view definition specified in a slot (described later). A view document resulting from the view evaluation is displayed on the pad by the rendering engine. At the same time, the mapping engine allocates the view information to the slots.

In addition, the view pad has an interval timer 109, which is used for polling WWW servers on the basis of a value specified in a slot for obtaining a live document updated from the original WWW document.

Web documents in general are defined in HTML format. The “HTML view” is a view that displays a portion of any HTML document defined in HTML format. The view pad is a pad wrapper that wraps given portions of a Web document. It can identify any HTML view and render the HTML document. The pad wrapper is hereinafter referred to as an HTMLviewPad.

In particular, the rendering function can be implemented by wrapping a conventional Web browser, such as Netscape® or Internet Explorer® for example. In the implementation of an exemplary embodiment, Internet Explorer® is wrapped. Accordingly, the document retriever 104, HTML document parser 105, and view document rendering engine 107, which are components of afore-mentioned view pad, are implemented by wrapping components of Internet Explorer. Such a view pad behaves as if it were a conventional Web browser. A user makes use of a live document of the present invention through operations, which will be described later, while using the view pad to search through the WWW according to his/her will.

View definition means that an HTML document is treated as a database, like RDB, and an “edit” for the HTML document is predefined to define a virtual view, just like RDB can define a virtual table or view by defining an “operation” for a table through the use of SQL.

The view pad of the present invention provides the function of automatically generating such view definitions in accordance with operations freely performed by a user on a GUI so that he or she can generate and manipulate a live document without difficulty.

The generation of view definitions will be described below.

Extracting an Optional Portion of a Web Document

(A) Obtaining and Editing an HTML Document

To obtain an HTML document for a view definition, the URL of a WWW server of interest and a variable name, “doc” for example, as the document reference variable are used with the function “getHTML” as shown below to search for the source document:

doc=getHTML(URL,REQUEST).

The second parameter REQUEST is used to specify a request to the Web server during search. Requests of this type include POST and GET. The document found is maintained in DOM format.

For the HTML document thus obtained, the view definition specifies a particular portion of the HTML document and a series of view editing operations on the specified portion as follows.

To specify a given HTML view on the given HTML document, the function of editing the internal representation, namely the DOM tree, of the HTML document is used. The DOM tree representation can use a path expression to identify any HTML document portion that matches a DOM tree node.

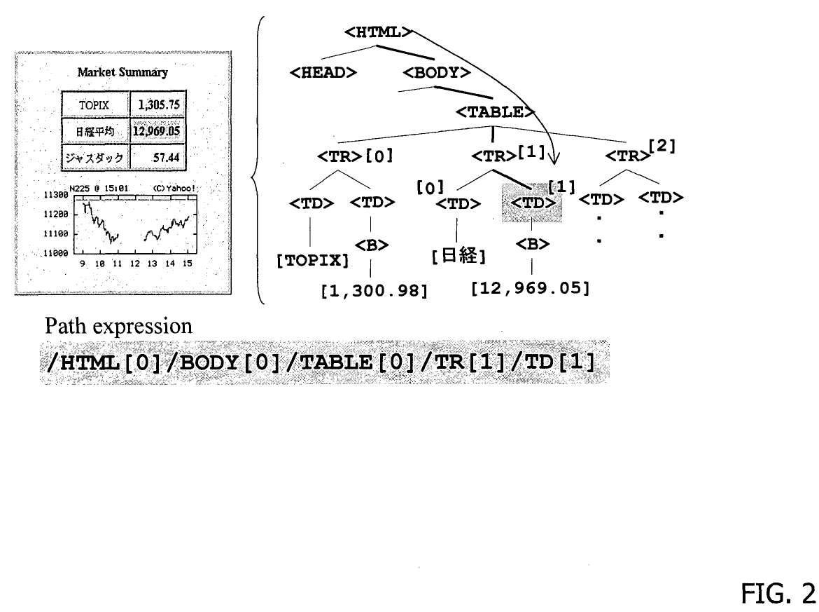

FIG. 2 shows an example of an HTML document and its DOM tree expression. The highlighted portion of the document in FIG. 2 matches the highlighted node whose path expression is

/HTML[0]/BODY[0]/TABLE[0]/TR[1]/TD[1].

A path expression is the linkage of the node identifier along the path from the route to a specified node. Each node identifier consists of the node name, namely the tag assigned to the node element, and the value indicating the number of brother nodes on the left side of that node (which corresponds to the order in which the brother elements appear).

If a node having a specified character string as a partial character string of the content of the original text among the brother nodes is required to be specified, character string pattern matching is used to specify the node as follows:

tag-name[MatchingPattern:index],

where MatchingPattern is the specified character string and “index” specifies one node among a number of brothers that meet the condition.

If a character string is required to be extracted from a text node, just a path expression, which can specify the location of that node, is not sufficient for determining the location of the partial character string. Therefore a regular expression is used for locating such a partial character string in the text node. The path expression is extended so that a regular expression pattern can be described inside the parentheses of the node operator txt( ) to specify the character string specified by the pattern as a virtual node, as shown below:

/txt(RegularExpression),

where RegularExpression represents a regular expression.

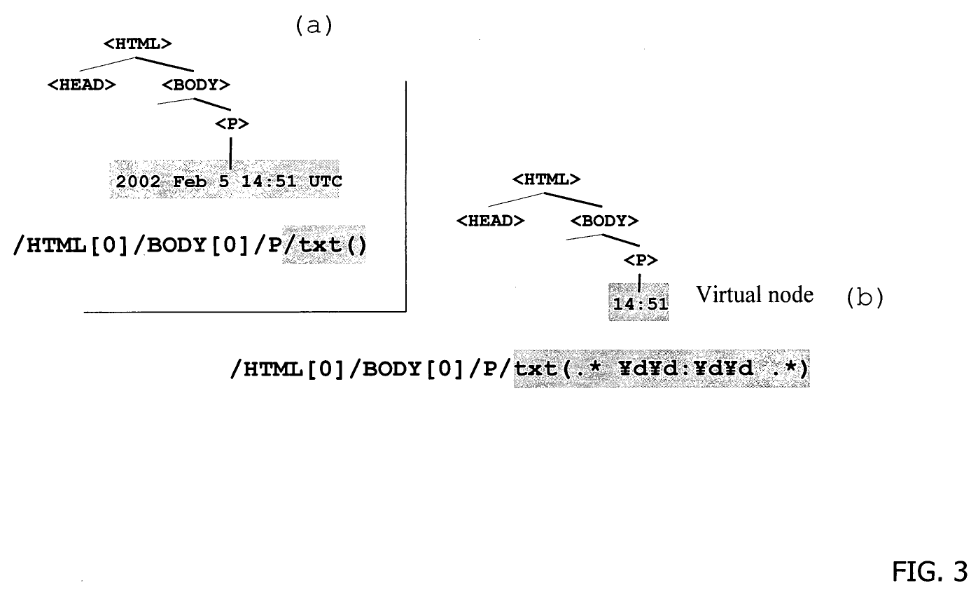

FIG. 3 shows a display example of the DOM tree and path expression of a virtual node. The node

/HTML[0]/BODY[0]/P/txt(.*(¥d¥d:¥d¥d).*)

specifies the virtual node shown in FIG. 3(b) for the DOM tree shown in FIG. 3(a).

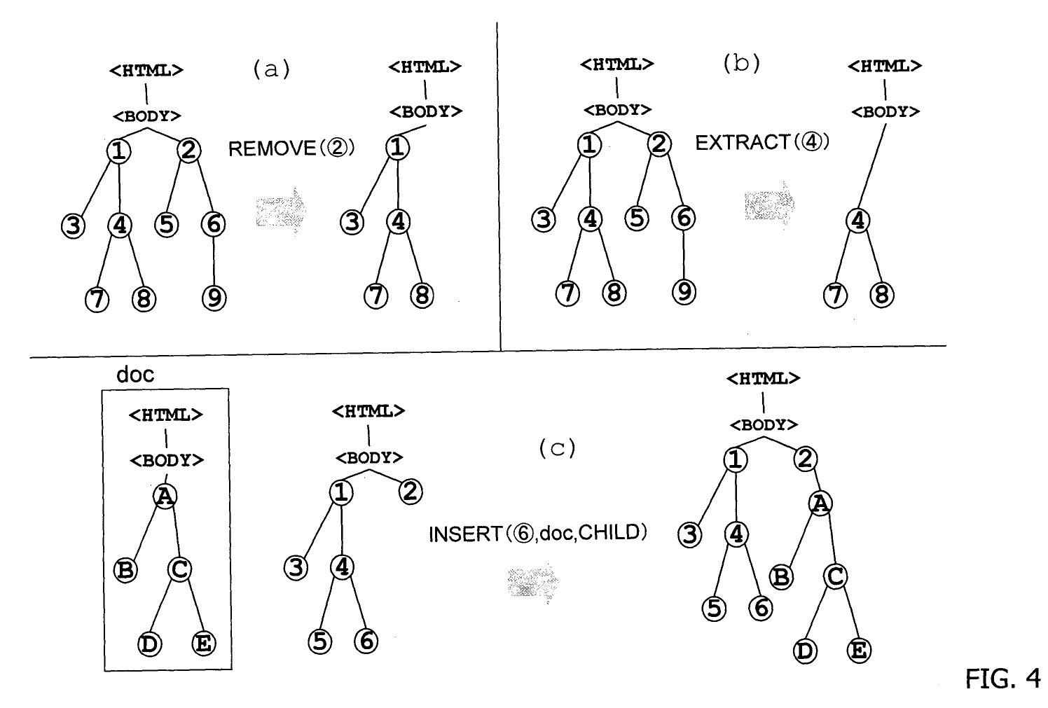

HTML view editing is a series of DOM tree manipulating operations selected from edit operators on the DOM tree, which are shown in FIG. 4 and described below.

(1) REMOVE: removes a sub-tree that has a specified node as its root (see FIG. 4(a)).

(2) EXTRACT: deletes all nodes except a sub-tree that has a specified node as its root (see FIG. 4(b)).

(3) INSERT: inserts a given DOM tree into a specified relative position of a specified node (see FIG. 4(c)).

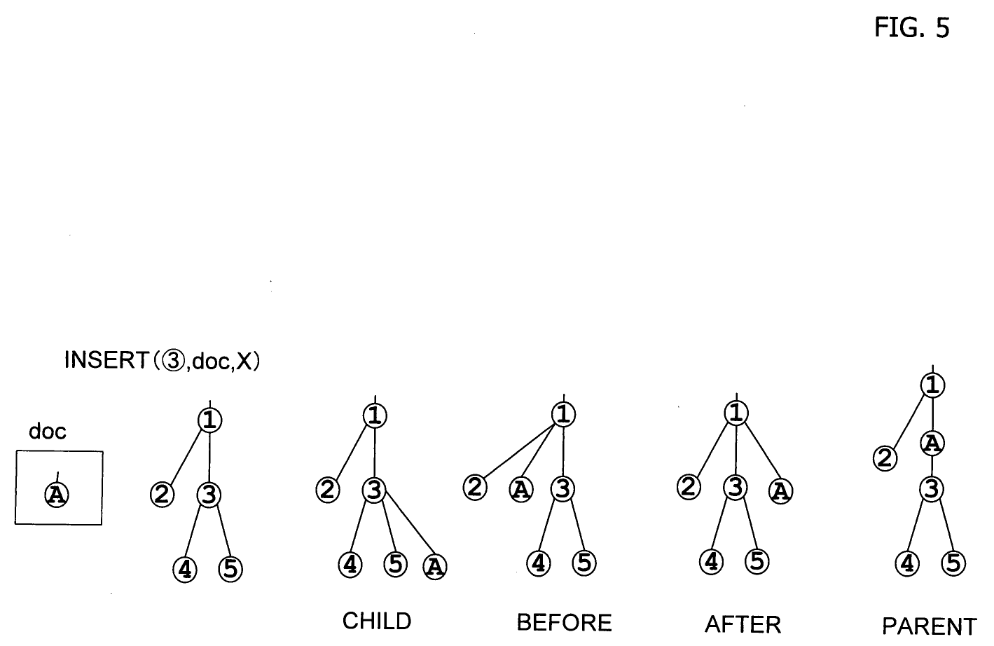

FIG. 5 shows a type of insertion by the INSERT operator. One of CHILD, PARENT, BEFORE, and AFTER can be selected as the relative position.

View definition is defined by the following expression with the specifications described above:

defined-view=source-view.DOM-tree-operation(node),

where “defined-view” represents a variable name of a view to be defined, “source-view” specifies a document to be edited, which may be a Web document or other HTML document, “tree-operation” represents an edit operator, and “node” represents an extended specification specified by its extension path expression.

An exemplary view definition in which the syntax described above is nested is shown below.

doc=getHTML(“http://www.abc.com/index.html”,null);

view=doc.EXTRACT(“/HTML/BODY/TABLE[0]/”)

view=view.EXTRACT(“/TABLE[0]/TR[0]/”)

view=view.REMOVE(“/TR[0]/TD[1]/”);

The repeat operation can be simplified as follows:

view1=doc

.EXTRACT(“/HTML/BODY/TABLE[0]/”)

.EXTRACT(“/TABLE[0]/TR[0]/”)

.REMOVE(“/TR[0]/TD[1]/”);

Furthermore, two sub-trees extracted from the same Web document or different Web documents can be specified and combined to define a view:

doc=getHTML(“http://www.abc.com/index.html”,null);

view2=doc

.EXTRACT(“/HTML/BODY/TABLE[0]/”)

.EXTRACT(“/TABLE[0]/TR[0]/”);

view1=doc

.EXTRACT(“/HTML/BODY/TABLE [0]/”)

.INSERT(“/TABLE[0]/TR[0]/”,view2,BEFORE);

The createHTML function can be used to create a new HTML document and insert it in an existing HTML document:

doc1=getHTML(“http://www.abc.com/index.html”,null);

doc2=createHTML(“<TR>Hello World</TR>”);

view1=doc1

.EXTRACT(“/HTML/BODY/TABLE[0]/”)

.INSERT(“/TABLE[0]/TR[0]/“,doc2,BEFORE);

(B) Direct Editing of the HTML View

The user does not need to describe the view definition codes described above but instead uses a mouse or other device to perform edit operations directly on the HTML view in a GUI environment. As a result, the codes are automatically generated. These operations will be described below.

The HTMLviewPad described above has at least four slots.

1. #UpdateInterval

This slot specifies time intervals at which periodical polling is performed by an HTTP server referenced. This slot specifies the time intervals to retrieve the latest web document from the HTTP server.

2. #RetrievalCode

This slot sets a document retrieval code in the view definition code.

3. #ViewEditingCode

This slot sets a view editing code in the view definition code.

4. #MappingCode

This slot sets a mapping-definition code. Whenever the #RetrievalCode slot or #ViewEditingCode slot is accessed by a set message, the source document is accessed and HTMLviewPad updates itself.

In addition, a mapping-definition code, which is set in the #MappingCode slot, can be specified to automatically generate a slot for assigning view definition information according to that code.

As described earlier, an HTMLviewPad can be dealt with in a manner similar to normal Web browsers when no view editing codes are set. When a document retrieval code (URL) is specified in the #RetrievalCode slot for an HTMLviewPad for which no newly generated slot value is set, the specified Web document is retrieved and displayed on the pad. As with a normal browser, clicking an anchor in the HTML document can change over from the document to a new document and the URL associated with the changed document is automatically reflected in the #RetrievalCode slot. Consequently, at the point of time when the document of interest is determined by this operation, a document retrieval code is automatically set.

In order to identify a node of the DOM tree of the HTML document obtained in this way, the user can identify any extractable document portions by repositioning the mouse cursor instead of specifying a path expression. To help this, the HTMLviewPad frames the extractable document portions corresponding to the position of the mouse.

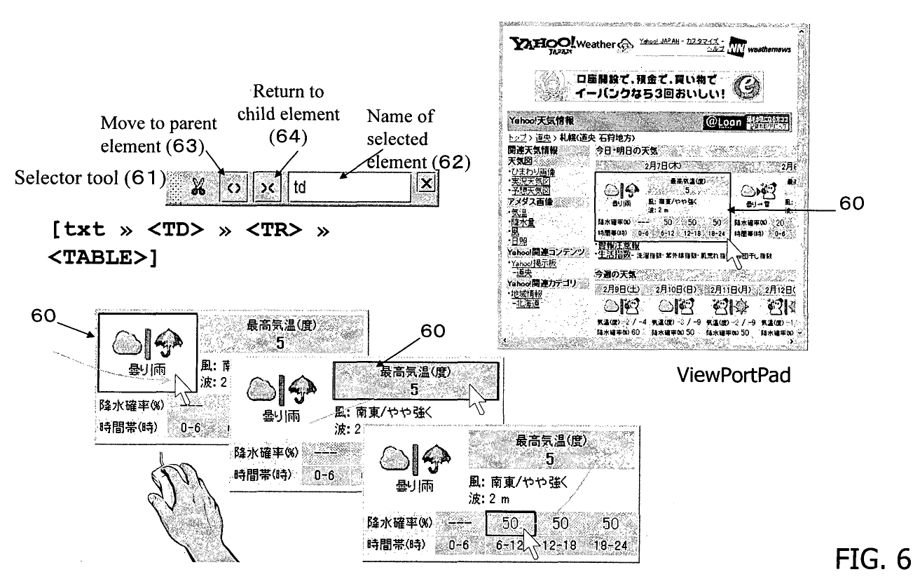

FIG. 6 illustrates this operation. Reference numeral 60 in this figure indicates areas pointed and framed by the user with the mouse pointer. In order to distinguish among different HTML objects having the same display area, an additional console panel 61 having two buttons and a node spec box is used. As the mouse is moved in order to select a different document portion, the node spec box 62 of the console panel changes its value. A first button 63 of the console panel is used for moving to the parent node in the corresponding DOM tree whereas a second button 64 is used for moving to the first child node.

In this way, the user can drag the mouse to frame a document portion to extract and create a separate HTMLviewPad having the extracted portion.

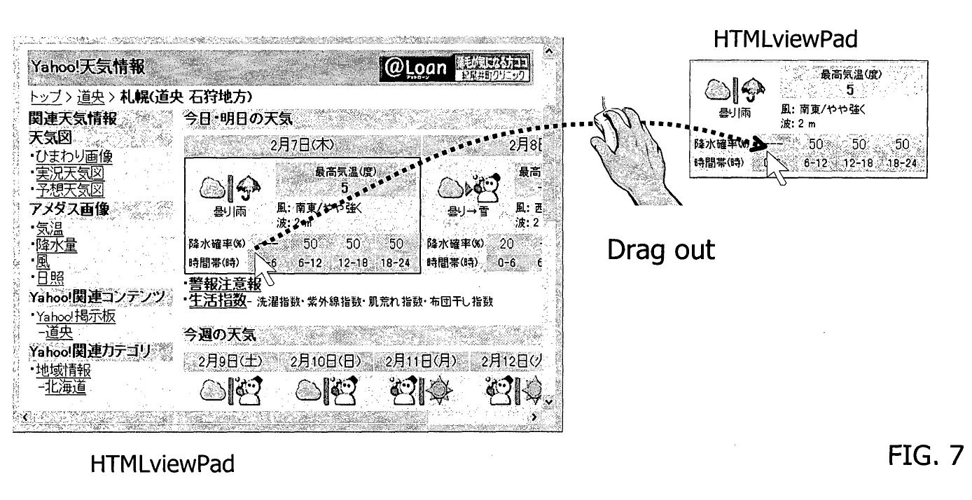

FIG. 7 shows an example in which this type of mouse drag operation is used for extraction. This operation is called drag-out.

When this operation is performed, the HTMLviewPad generates a new HTMLviewPad and copies its own view definition code into the newly generated pad. Furthermore, an EXTRACT instruction to the specified position is appended to the copied view editing code. The new HTMLviewPad renders the extracted DOM tree on itself to display a view. When generating the new pad, the size of the pad can be set to the size of the extracted element so that an interface can be achieved that provides the appearance of a “cut.” An edit code internally generated by this operation is shown below.

doc=getHTML(“http://www.abc.com/index.html”,null);

view=doc

.EXTRACT(“/HTML/BODY/ . . . /TABLE[0]/”);

After framing a portion to manipulate by the HTMLviewPad, the HTMLviewPad displays a pop-up menu of view editing operations, including EXTRACT, REMOVE, and INSERT operations through a mouse operation. After selecting a portion in this way, the user can select one of EXTRACT and REMOVE.

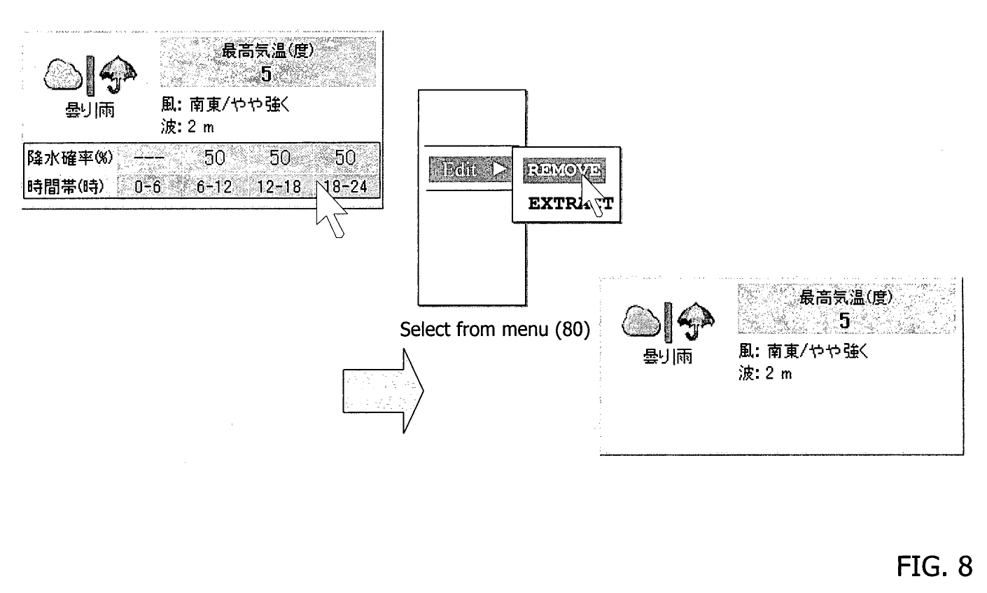

FIG. 8 shows an example of the REMOVE operation, which. generates the following codes:

doc=getHTML(“http://www.abc.com/index.html”,null);

view=doc

.EXTRACT(“/HTML/BODY/TABLE[0]/”)

.REMOVE(“/TABLE[0]/TR[1]/”);

The INSERT operation uses two HTMLviewPads indicating source and target HTML documents. The INSERT operation is first selected from the menu and then a document portion to be inserted directly is specified. A position on the target document in which the portion is to be inserted is specified by specifying the relative position from the menu containing CHILD, PARENT, BEFORE, and AFTER. Then a document portion on the source document is directly selected and dragged and dropped to the target document.

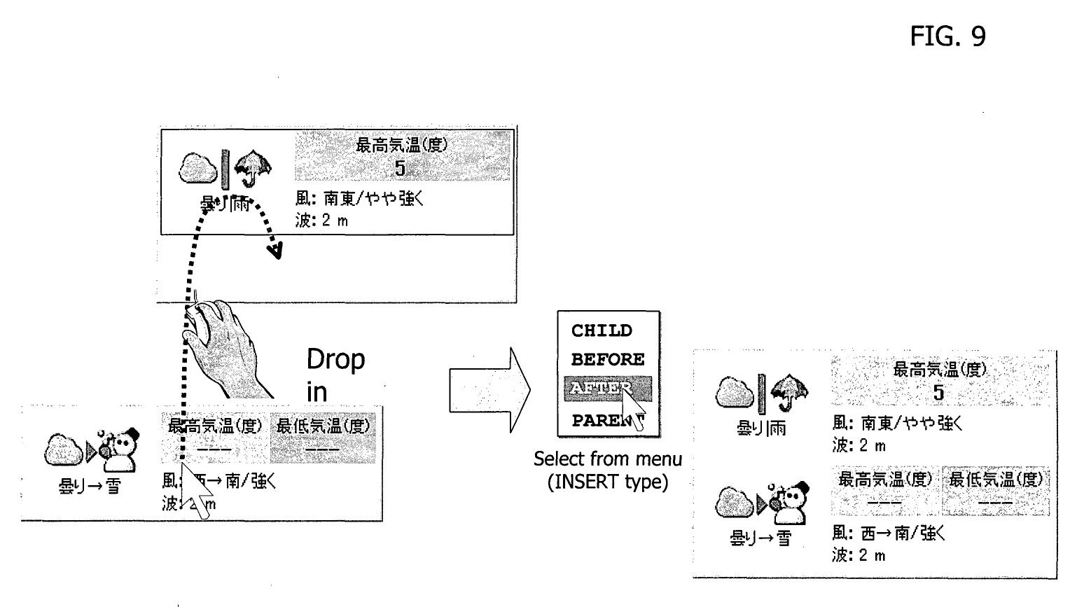

FIG. 9 shows an example of the INSERT operation which generates the code shown below. In this example the target HTMLviewPad uses a different name space to merge an edit code of an external HTMLviewPad dragged to an edit code of the target HTMLviewPad.

A::view=A::doc

.EXTRACT(“/HTML/BODY/ . . . /TD[1]/ . . . /TABLE[0]”)

.REMOVE(“/TABLE[0]/TR[1]/”);

view=doc

.EXTRACT(“/HTML/BODY/ . . . /TD[0]/. ./TABLE[0]/”)

.REMOVE(“/TABLE[0]/TR[1]/”)

.INSERT(“/TABLE[0]”, A::view,AFTER);

The HTMLviewPad dropped is deleted after the insertion.

(C) Data Mapping for Defining a Slot

An HTMLviewPad maps information contained in a view to display to its slot value. This allows the view information to be accessed from outside the pad. At the same time, an event having occurred in the HTMLviewPad can be mapped to a slot value. A Mapping-Definition Code determines how view information is mapped to a slot. This code, which is also provided as a slot value, is automatically set by the system without being specified by the user, or generated by an operation by the user on the GUI, like the other codes. An HTMLviewPad can map any node value of its view and any event on the view to a newly defined slot. The mapping definition uses the following format.

MAP(<node>,NameSpace)

Here <node>represents a node type specifying expression. Mapping is specified on a node basis in this way. NameSpace is used by the system for naming a slot. A specific example of the mapping definition is shown below.

MAP(”/HTML/BODY/P/txt( )”, “#value”)

The HTMLviewPad changes node value evaluation according to the type of the node in order to map an optimum value for the selected node to the newly defined slot. The rules for the evaluation are called node mapping rules. Each node mapping rule has the following syntax.

target-object=>naming-rule(data-type)<MappingType>

Here “target-object” represents an object to be mapped, “naming-rule” represents the naming rule for the slot to which the object is mapped, “data-type” represents the data type of the slot to which the object is mapped, and “MappingType” is one of <IN|OUT|EventListener|EventFire>.

A slot defined by the OUT type is read-only. The IN type mapping defines a rewritable slot. Rewriting a slot of this type can change the display of an HTML view document. The EventListener type mapping defines a slot whose value changes whenever an event occurs on a selected node on the screen. On the other hand, the EventFire type mapping defines a slot that triggers an event specified within a node the updating of which is selected on the screen.

For typical nodes such as </HTML/ . . . /txt( )>, </HTML/ . . . /attr( )>, or </HTML/ . . . /P/>, the HTMLviewPad defines a slot and sets text in a selected node in that slot. If the text is a numeric character string, it converts the character string into a numeric value and sets in the slot.

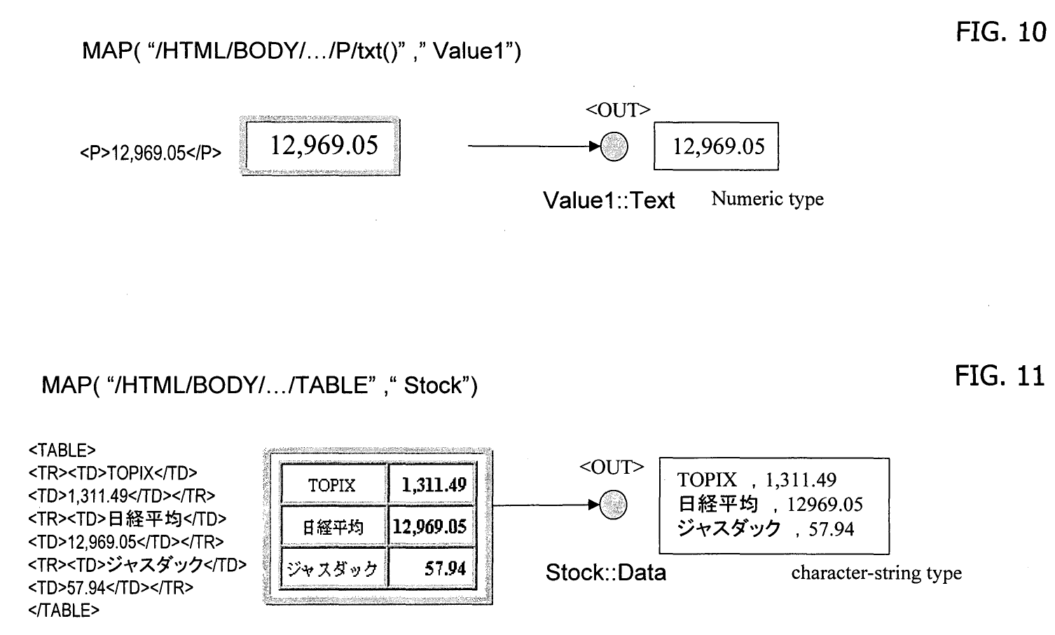

FIG. 10 shows mapping of a text character string node for defining a slot.

Text (a character string) in the selected node=>NameSpace::#Text(string)<OUT>

Text (a numeric character string) in the selected node=>NameSpace::#Text(number)<OUT>

For a table node such as</HTML/ . . . /TABLE/>, the HTMLviewPad converts a table value into a CSV (Comma-Separated Value) expression and maps it to a newly defined slot of text type.

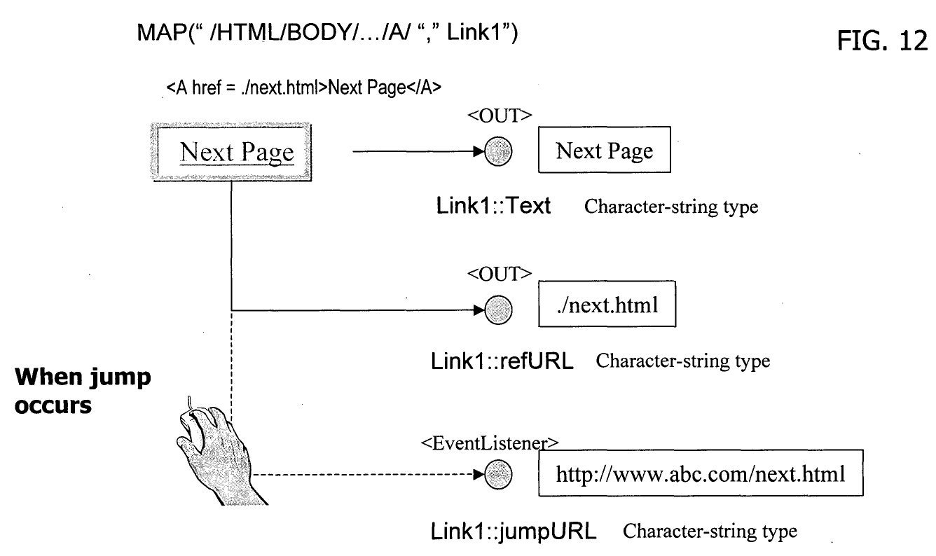

FIG. 11 shows mapping of a table node for defining a slot.

For an anchor node such as</HTML/ . . . /A/>, the HTMLviewPad performs the following three mappings.

Text in the Selected Node

=>NameSpace::#Text(string, number)<OUT>

The href Attribute of the Selected Node

=>NameSpace::#refURL(string)<OUT>

The URL of the Target Object

=>NameSpace::#jumpURL(string)<EventListener>

The third mapping has the EventListener type. Whenever the anchor is clicked, the target URL is set to a character-string type slot.

FIG. 12 shows mappings of anchor elements for defining the three slots.

For a form node such as</HTML/ . . . /FORM/>, the HTMLviewPad performs the following three mappings.

The Value Attribute of an INPUT Node Having the Name Attribute of the Selected Node

=>NameSpace::#Input#type#name(string,number)<IN,OUT>

Submit Operation

=>NameSpace::#FORM#Submit(boolean)<EventFire>

A Value Obtained from a Server

=>NameSpace::#FORM#Request(string)<EventListener>

type=

<text|password|file|checkbox|radio|hidden|submit|reset|butt on|image>

name=INPUT node <name>attribute

The third mapping has the EventListener type. Whenever an event that sends a form request occurs, the HTMLviewPad sets a corresponding query for the newly defined slot. The second mapping is an EventFire type mapping. Whenever TRUE is set for the slot, the HTMLviewPad triggers a form request event.

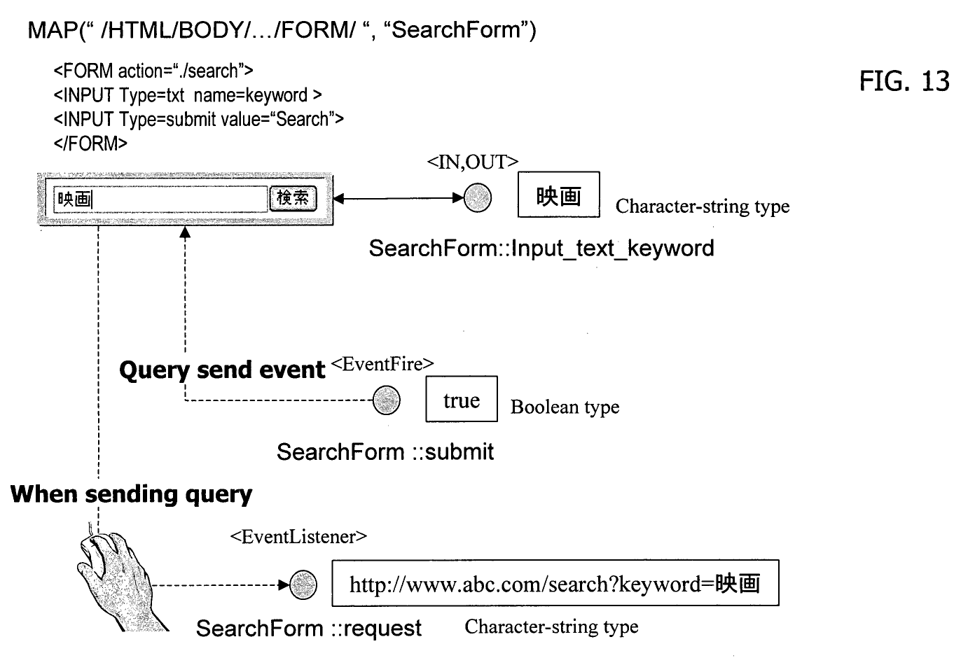

FIG. 13 shows mappings of form elements for defining these three slots.

Advantages of the present invention will be illustrated with respect to exemplary applications.

(A) Live Copy of Numeric Data

An HTMLviewPad can extract any HTML element from a Web document displayed. Directly dragging out a portion to extract, another HTMLviewPad indicating the extracted portion is generated. The periodical polling function of the latter HTMLviewPad keeps the extracted document portion alive. This type of copy of a document portion is called a live copy. A live copy can be pasted onto another pad having a slot connection for combining functions. Moreover, an ordinary pad can be pasted onto a live copy and the former pad can be connected to one of the slots of the latter pad. This type of operation can compose an application pad that integrates live copies of a plurality of document portions extracted from different Web pages.

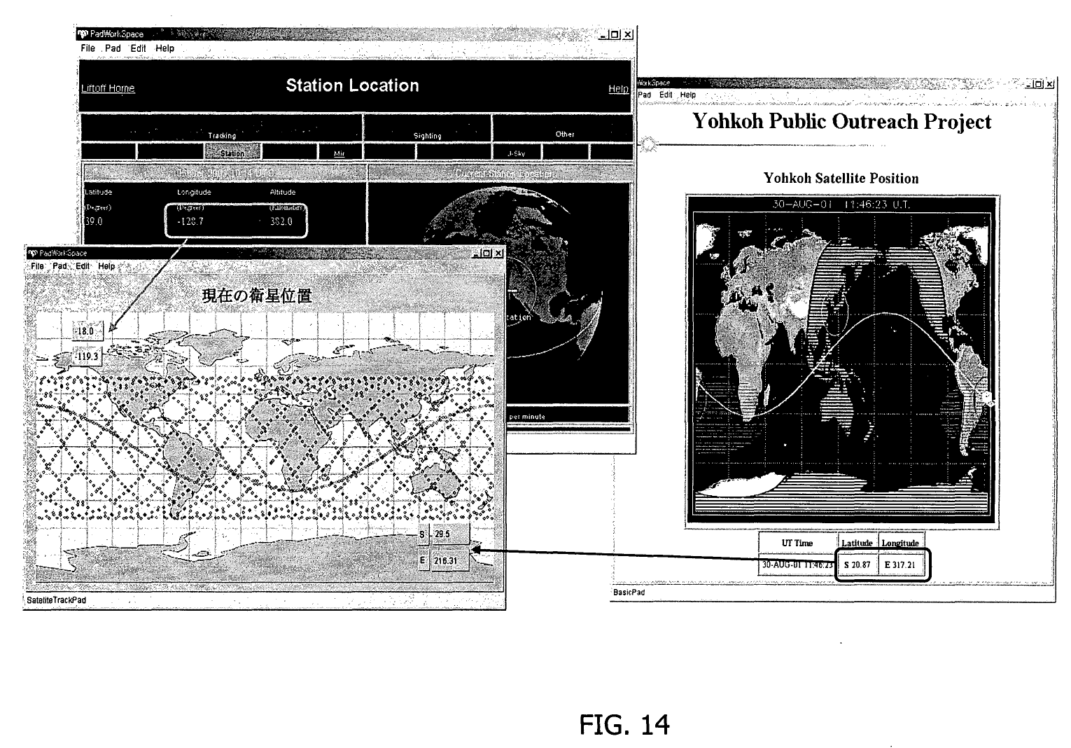

FIG. 14 shows a plotting of the orbits of the NASA Space Station and the Yohkoh satellite. A world map pad is used in conjunction with a plotting function. This map pad has a pair of slots: the #longitude[1]slot and the #latitude[1]slot. It generates a set of slots of the same type having different indexes in response to a request from a user. It first accesses the homepages of the Space Station and the satellite. Indicated in these pages are the longitude and latitude of the current location of the Space Station and the satellite. A live copy of the longitude and latitude in each of these Web pages is created. The copies are pasted onto the world map pad through the use of connections to their respective #longitude[i] slot and the #latitude[i] slot. The live copies from the Space Station Web page use a first pair of slots and the live copy from the satellite Web page uses a second slot pair. These live copies poll their source Web pages to update their values every ten seconds. The separate two sequences of plotted locations indicate the orbits of the Space Station and the satellite.

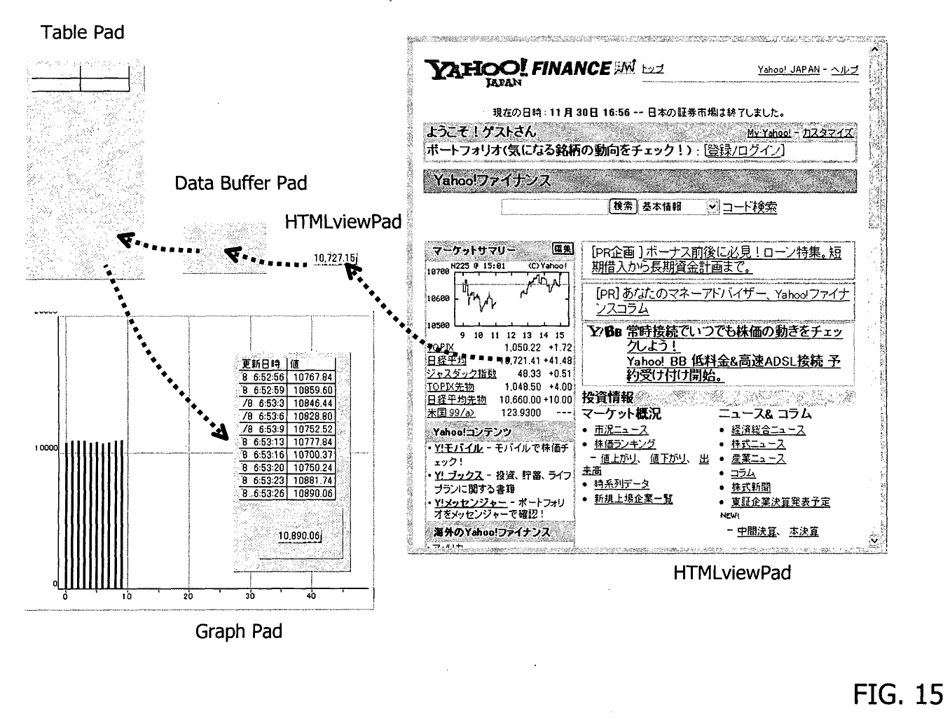

FIG. 15 shows an application in which fluctuations in stock prices are visualized in real time. The Yahoo Finances Web page which indicates the current Nikkei stock average in real time is first accessed. A live copy of the Nikkei average index is created and pasted onto a DataBufferPad along with its connection to a #input slot. The DataBufferPad associates each #input slot input with input time and outputs the pair in CSV format. The composite pad is pasted onto a TablePad along with its connection to a #data slot. The TablePad appends every #data slot input to a list stored in CSV format. In order to paste the pad on to a GraphPad along with the connection to the #input slot, the main slot of the TablePad is changed to #data slot. Whenever it receives a new #input slot value, the GraphPad displays an additional vertical bar proportional to that input value.

(B) Live Copy of Table Data

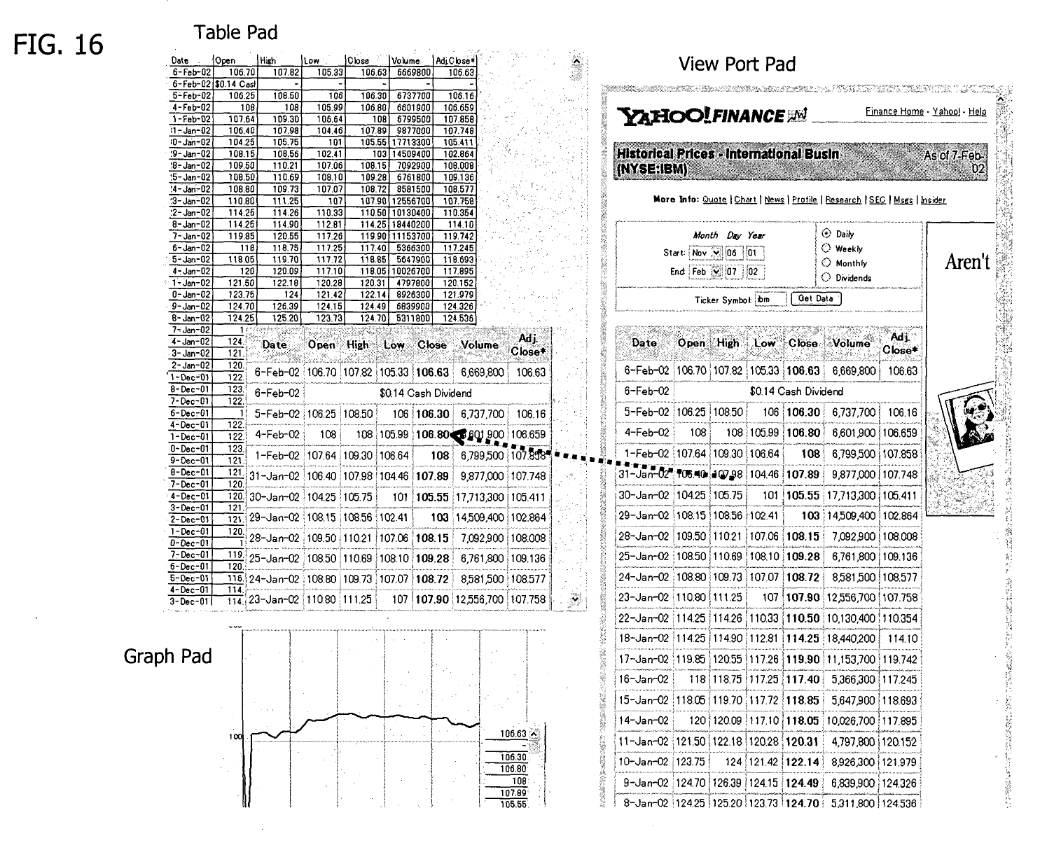

FIG. 16 shows another Yahoo Finance® service page. This page indicates time-series stock prices of a specified company during a specified period of time. A live copy of this table is created and pasted onto a TablePad along with its connection to the #input slot. The extracted table content is sent to the TablePad in CSV format. A chart shown in FIG. 16 can be presented by pasting the live copy onto the GraphPad along with the connection to a #list slot.

(C) Live Copy of Anchor

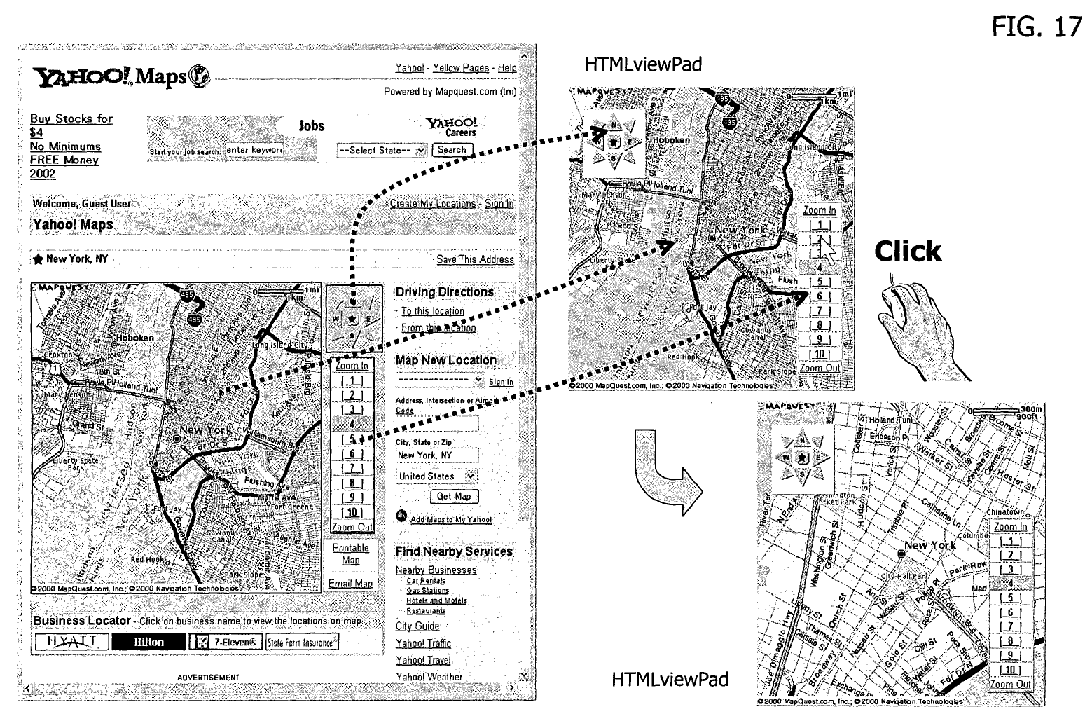

FIG. 17 shows a Yahoo Maps® Web page. This page provides a map of a specified location and its surrounding areas. Live copies of its map display area, zoom control panel, and shift control panel are created and the two control panels are pasted onto the map display along with the connection to the #RetrievalCode slot of the map display. Whenever any button on one of the control panels is clicked, that control panel sets the URL of a requested page and sends the URL to the #RetrievalCode slot of the map display. The map display accesses the requested page on the new map and extracts its map area to display it.

(D) Redistributing a Live Copy

When saving a live copy extracted from a Web document, the system saves only the pad type, namely “HTMLviewPad,” and values of two slots, the #RetrievalCode slot and the #ViewEditingCode slot. The live copy shares only these values with its original. Redistribution of a live copy on the Internet can be accomplished simply by sending its saved format representation. When the sent live copy is activated on the destination platform, a search code stored in the #RetrievalCode slot is activated and a view editing code in the #ViewEditingCode slot is executed in order to display only the definition part of a found Web document. Any portion of it can further be extracted as a live copy.

The description of the present embodiment has been provided by way of illustration only and is not intended to limit the present invention to the specific embodiment. It will be apparent to those skilled in the art that various modifications can be made to the embodiment without departing from the scope of the present invention. For example, while the arrangement has been described in which components of Internet Explorer® are wrapped in IntelligentPad as the HTMLviewPad, the present invention is not limited to this arrangement. It is apparent that a new object having the complete functions required for implementing the present invention may be newly created and such variations fall within the scope of the present invention.

What is claimed is:

1. A method for re-editing a Web document, comprising the steps of:
wrapping a given Web document portion together with its style and/or dynamic content as an object;
updating the dynamic content of said object on a regular basis; and
re-editing the Web document by combining said object with another object and/or decomposing said object.

2. The method according to claim 1, wherein:
said step of wrapping comprises the steps of automatically recording and modifying information identifying the original Web document portion and retrieving and storing the identified Web document portion;
said step of updating comprises the step of polling the original Web document portion at predetermined intervals; and
said step of re-editing comprises the step of automatically recording and modifying edit information according to an operation on the object.

3. The method according to claim 1 or 2, further comprising the step of saving information about the definition of said object and reference information and edit information about the re-edited original Web document.

4. A program for causing a computer to perform the steps of:
wrapping a given Web document portion together with its style and/or dynamic content as an object;
updating the dynamic content of said object on a regular basis; and
re-editing the Web document by combining said object with another object and/or decomposing said object.

5. A computer-readable storage medium having stored thereon a program for causing a computer to perform the steps of:
wrapping a given Web document portion together with its style and/or dynamic content as an object;
updating the dynamic content of said object on a regular basis; and
re-editing the Web document by combining said object with another object and/or decomposing said object.

6. A method for re-editing a Web document, comprising the steps of:
retrieving the Web document from a Web server according to an operation by a user or given information;
analyzing the retrieved Web document;
editing the analyzed Web document according to a user operation or view definition information;
generating, modifying, and managing the view definition information according to an edit operation by said user;
displaying the edited Web document;
mapping information including said view definition information to an external interface; and
polling the original Web server according to given information.

7. A program for causing a computer to perform the steps of:
retrieving the Web document from a Web server according to an operation by a user or given information;
analyzing the retrieved Web document;
editing the analyzed Web document according to a user operation or view definition information;
generating, modifying, and managing the view definition information according to an edit operation by said user;
displaying the edited Web document;
mapping information including said view definition information to an external interface; and
polling the original Web server according to given information.

8. A computer-readable storage medium having stored thereon a program for causing a computer to perform the steps of:
retrieving the Web document from a Web server according to an operation by a user or given information;
analyzing the retrieved Web document;
editing the analyzed Web document according to a user operation or view definition information;
generating, modifying, and managing the view definition information according to an edit operation by said user;
displaying the edited Web document;
mapping information including said view definition information to an external interface; and
polling the original Web server according to given information.

9. An apparatus for re-editing a Web document, comprising:
means for retrieving a Web document from a Web server according to an operation by a user or given information;
means for analyzing the retrieved Web document;
means for editing the analyzed Web document according to a user operation or view definition information;
means for generating, modifying, and managing the view definition information according to an edit operation by said user;
means for displaying the edited Web document;
means for mapping information including said view definition information to an external interface; and
means for polling the original Web server according to given information.

10. A program for causing a computer to operate as a Web-document re-editing apparatus comprising:.0
means for retrieving a Web document from a Web server according to an operation by a user or given information;
means for analyzing the retrieved Web document;
means for editing the analyzed Web document according to a user operation or view definition information;
means for generating, modifying, and managing the view definition information according to an edit operation by said user;
means for displaying the edited Web document;
means for mapping information including said view definition information to an external interface; and
means for polling the original Web server according to given information.

11. A computer-readable storage medium having stored thereon a program for causing a computer to operate as a Web-document re-editing apparatus comprising:
means for retrieving a Web document from a Web server according to an operation by a user or given information;
means for analyzing the retrieved Web document;
means for editing the analyzed Web document according to a user operation or view definition information;
means for generating, modifying, and managing the view definition information according to an edit operation by said user;
means for displaying the edited Web document;
means for mapping information including said view definition information to an external interface; and
means for polling the original Web server according to given information.
